(19) United States
(12) Patent Application Publication
(10) Pub. No.: US 2006/0186833 A1
(43) Pub. Date: Aug. 24, 2006

(54) FLUORESCENT TUBE DRIVER CIRCUIT SYSTEM OF PULSE-WIDTH MODULATION CONTROL

(76) Inventors: Chung-che Yu, Taipei City (TW); Tsu-ming Yu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,497

(22) Filed: Feb. 23, 2005

(51) Int. Cl. H05B 41/36

(52) U.S. Cl. 315/307

(57) ABSTRACT

A fluorescent tube driver circuit system of pulse-width modulation control and an operating method thereof are provided. The fluorescent tube driver circuit system of pulse-width modulation control comprises a fixed-frequency generator and a pulse-width modulator. The fixed-frequency generator receives a turn-on detecting signal for indicating a turn-on state of the fluorescent tube and decides to output a pulse signal with a first frequency or a second frequency. The pulse-width modulator can receive a feedback signal for indicating the current passing through the fluorescent tube and the pulse signal with the first frequency or the second frequency, and operate the feedback signal and the pulse signal to output a first and a second control signals.

### BACKGROUND OF THE INVENTION

1. Field of the Invention

The present invention generally relates to a fluorescent tube driver circuit system of pulse-width modulation control. More particularly, the present invention relates to a pulse-width modulation control circuit, a fluorescent tube driver system and an operating method thereof.

2. Description of Related Art

Currently, the required current frequency range of operating a cold cathode fluorescent tube is about 30 KHz˜80 KHz (a sinusoidal wave without a DC component) wherein the stable operating voltage of the tube is nearly a constant. The brightness of the tube is determined by a current passing through it but the required voltage for initiating the tube is 2˜2.5 times that used in a normal stable operating state. At present, in the case of a required voltage for initiating the cold cathode fluorescent tube, the operating voltage of the tube is usually determined by its size. For example, in the case of the cathode fluorescent tube employed in a 14″ or 15″ LCD, the initiating voltage is about 1400 Vrms, the rated operating current is 7 mA and the operating voltage is about 650 Vrms. In operating the tube, a pulse-width modulation control converter with a fixed frequency converts an inputted direct current to a symmetrical alternating current, which is a common control method of an electronic stabilizer for modulating light emitting from the cathode fluorescent tube.

Referring to FIG. 1, a circuit block diagram of a conventional fluorescent tube driver system of pulse-width modulation control is shown. The fluorescent tube driver system 100 comprises a pulse signal generator 102, a pulse-width controller 104, a feedback voltage detecting circuit 110, a DC voltage source 112, a first power switch 108a, a second power switch 108b, a transformer 114, a ballast capacitor 116 and a fluorescent tube 118.

In prior art, the pulse-width modulation controller 104 will operate a fixed frequency outputted from the pulse signal generator 102 and a feedback voltage 110a generated by the lamp current, detected by the feedback voltage detecting circuit 110, passing through the fluorescent tube 118, and then outputs a first control signal 106a for controlling the first power switch 108a and a second control signal 106b for controlling the second power switch 108b. The transformer 114 will determine the power supplied to the fluorescent tube 118 from the DC voltage source 112 through the transformer 114 and the ballast capacitor 116 as if the first power switch 108a and the second power switch 108b are turned on.

Referring to FIG. 2, a wave diagram of the first and the second conventional control signals are shown. In the conventional technique, the first and the second control signals are square waves with the same frequency, 180° phase shift and largest operating cycle being less than 50%. The transformer 114 generates output powers with different magnitudes by use of the first power switch 108a and the second power switch 108b with different magnitudes of operating cycles.

In addition, the U.S. Pat. Nos. 6,114,814, 6,316,881B1 and 6,633,138B2, wherein the U.S. Pat. No. 6,633,138B2 is a divisional application of U.S. Pat. No. 6,316,881B1 which in turn is a divisional application of U.S. Pat. No. 6,114,814, disclose a DC/AC inverter circuit for driving a load. The DC/AC inverter circuit comprises a tank circuit, a network of a plurality of switches and a controller. Besides, the controller employs a resonant frequency of the tank circuit to control the oscillation of the plurality of switches between open and closed positions. Therefore, the U.S. Pat. Nos. 6,114,814, 6,316,881B1 and 6,633,138B2 utilize an AC signal with the resonant frequency to drive the load. Moreover, the U.S. Pat. Nos. 6,259,615B1, 6,396,722B2 and 6,804,129B2, wherein the U.S. Pat. No. 6,396,722B2 is a continuation application of U.S. Pat. No. 6,259,615B1 and U.S. Pat. No. 6,804,129B2 is a continuation application of U.S. Pat. No. 6,396,722B2, disclose a high-frequency adaptive DC/AC converter. The high-frequency adaptive DC/AC converter comprises a plurality of switches, a transformer, a load, a pulse generator and a feedback control circuit. More, column 6, rows 36-44 in U.S. Pat. Nos. 6,396,722B2 and 6,804,129B2, (column 6, rows 24-33 in U.S. Pat. No. 6,259,615B1) disclose “high frequency operation is achieved through a zero-voltage-switching technique” and “with this controlled operation, switching loss is minimized and high frequency is maintained.” Therefore, the U.S. Pat. Nos. 6,259,615B1, 6,396,722B2 and 6,804,129B2 utilize an AC signal with the high frequency to drive the load. So, all prior art described above utilize a pulse signal with a resonant frequency to drive the load (i.e. a fluorescent lamp).

Furthermore, a Linfinity Microelectronics located in Garden Grove, Calif., is an applicant of U.S. Pat. Nos. 5,930,121, 5,923,129, 5,615,093, 6,198,234B1 and 6,469,922B2. The last paragraph in the “SUMMARY OF THE INVENTION” In the U.S. Pat. Nos. 5,930,121 and 5,923,129 discloses “The increasing frequency results in an increasing voltage on the secondary of the transformer to aid in striking the lamp.” However, these two patents utilize a special designed oscillator, which may generate infinite different frequencies, sweep the operation frequencies from a low frequency to a high frequency for obtaining a proper operation frequency to be applied to the transformer and thus result in a circuit design complexity. More, the U.S. Pat. No. 6,198,234B1 discloses that dimming a brightness of a fluorescent lamp is conducted by adjusting a current following to the lamp in accordance with a temperature of the lamp. In addition, the U.S. Pat. No. 6,198,234B1 discloses that both current amplitude and current duty cycle are used to more precisely control the lamp light output.

In view of the prior art mentioned above, they utilize the pulse signal with the high frequency and the additional duty control circuit to strike (igniting) the fluorescent lamp and break the strike for operating the lamp in a normal state. However, when passing the pulse signal with the high frequency through a parasitic capacitance of the circuit, there occurs dissipation in the capacitance. In addition, the additional duty control circuit is needed to break the striking the lamp, which thereby results in a circuit design complexity.

Meanwhile, as mentioned in the foregoing, the conventional fixed frequency applying to the current fluorescent cathode tube has several drawbacks. In current LCD applications, the DC voltage source supplied by the system has only more than 10 V, but as shown in FIG. 1, the cathode fluorescent tube converter controlled by a pulse-width modulation method to adjust its output requires a coil set with a very high coil number ratio to attain a voltage 2˜3 times higher than that used in a normal operating state for igniting the tube. However, the higher the coil number ratio is, the more difficult the design of the coil set is, thereby reducing the efficiency of a system.

Accordingly, to solve problems as mentioned above, there is a need to provide a fluorescent lamp driver circuit system with a simpler and feasible driver circuit to be used in striking the lamp and restoring the circuit to a normal operating state.

### SUMMARY OF THE INVENTION

Accordingly, the present invention is directed to a pulse-width modulation control circuit, which determines and then generates two set different fixed frequencies by detecting if the tube is turned on.

The present invention is further directed to a fluorescent tube driver control system, which employs two set different fixed frequencies to operate a turn-on frequency of a power switch circuit, thereby reducing the difficulty in designing a transformer, and further increasing the efficiency of the system.

The present invention is further directed to an operating method of a fluorescent tube driver control system, which employs two set fixed frequencies to drive the fluorescent tube when the fluorescent tube has different requirements in both igniting and normal operating states.

According to an embodiment of the present invention, a turn-on modulation control circuit is provided. The circuit comprises a fixed frequency generator, and a pulse-width modulator. The fixed frequency generator receives a turn-on detecting signal for detecting the turn-on state of the fluorescent tube and determines to output first and second frequencies in accordance with received turn-on detecting signal. The pulse-width modulator receives the feedback voltage and operates by passing current through the fluorescent tube and the first frequency or the second frequency for outputting a first and a second control signals.

According to an embodiment of the invention, the first and the second control signals have 180° phase shift.

A fluorescent tube driver control system is provided according to the present invention. The system comprises a DC voltage source, a fluorescent tube, a detecting circuit, a pulse-width modulation control circuit, a transformer unit and a power switch circuit. The detecting circuit detects the operating status of the fluorescent tube and outputs a turn-on detecting signal for indicating the turn-on state of the fluorescent tube and a feedback voltage generated by passing the current through the fluorescent tube. The pulse-width modulation control circuit comprises a fixed frequency generator and a pulse-width modulator, wherein the fixed frequency generator receives a turn-on detecting signal and determines to output a pulse signal with a first and a second frequency in accordance with the received turn-on detecting signal. In the meanwhile, the pulse-width modulator receives the feedback voltage and the pulse signal with the first frequency or the second frequency and operates the feedback signal and the pulse signal to output a first control signal and a second control signal. The transformer will supply the alternating current to the fluorescent tube. The power switch circuit receives the first and second control signals and determines to output the magnitude of the alternating current generated from the DC voltage source and through the transformer in accordance with the received first and second control signals.

The power switch circuit comprises two power switches, both of which have at least one ground terminal.

The embodiment of the invention further comprises a circuit with a dimming initiating function and the timing of dimming initiating function is determined in accordance with the turn-on detecting signal.

The embodiment of the invention further comprises a protection circuit for determining and changing the first and second signals for accomplishing a protection function according to the turn-on detecting signal.

In conclusion, the present invention employs two set fixed frequencies to drive the fluorescent tube in accordance with the requirements of the features of the fluorescent tube so that the fluorescent tube according to the present invention can be ignited and driven with a low coil number ratio transformer, thereby reduce the difficulties in designing the transformer and thus increase the efficiency of the system.

The objectives, other features and advantages of the invention will become more apparent and easily understood from the following detailed description of the invention when taken in conjunction with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional fluorescent tube driver system of pulse-width modulation control.

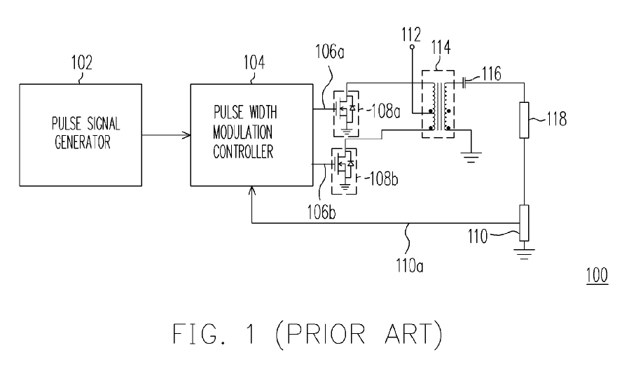

FIG. 2 is a wave diagram of first and second conventional control signals.

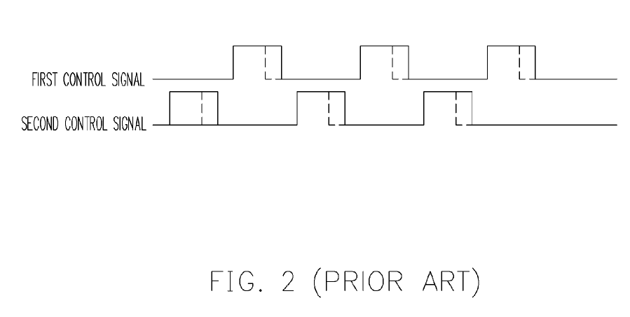

FIG. 3 is a block diagram of a fluorescent tube driver circuit system of pulse-width modulation control according to the first embodiment of the invention.

FIG. 4 is a flow chart of an operating method of a fluorescent tube driver control system, according to the first embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention employs two set fixed frequencies to drive the fluorescent tube in accordance with the requirements of the features of the fluorescent tube so that the fluorescent tube according to the present invention can be ignited and driven with a low coil number ratio transformer, thereby reducing the difficulties in designing the transformer and thus increase the efficiency of the system.

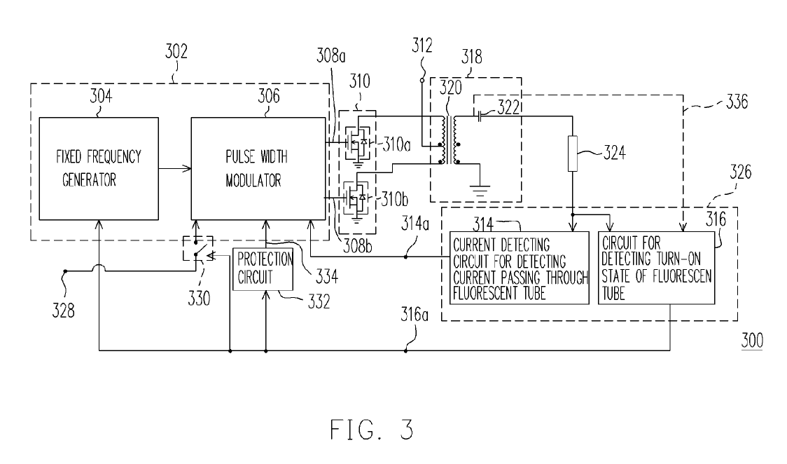

Referring to FIG. 3, a block diagram of a fluorescent tube driver circuit system of pulse-width modulation control according to the first embodiment of the invention is shown. In FIG. 3, the system 300 comprises a pulse-width modulation control circuit 302, a detecting circuit 326, a power switch circuit 310, a transformer unit 318 and a fluorescent tube 324. As it would be understood by those skilled in the art that the fluorescent tube may be a cold cathode fluorescent tube, but not limited to.

In this embodiment, the detecting circuit 326 comprises a current detecting circuit 314 for detecting the current passing through the fluorescent tube and a turn-on detecting circuit 316 for detecting the turn-on state of the fluorescent tube, wherein the current detecting circuit 314 is electrically coupled to the fluorescent tube 324 and outputs a feedback voltage 314a according to the current passing through the fluorescent tube 324. The turn-on detecting circuit 316 is electrically coupled to the fluorescent tube 324 and outputs a turn-on detecting signal 316a for indicating whether the fluorescent tube is turned on.

The pulse-width modulation control circuit 302 comprises a fixed frequency generator 304 and a pulse-width modulator 306, wherein the fixed frequency generator 304 is electrically coupled to the turn-on detecting circuit 316 and receives a turn-on detecting signal 316a and determines to output a pulse signal with a first and a second frequencies in accordance with the received turn-on detecting signal 316a. The pulse-width modulator 306 is electrically coupled to the fixed frequency generator 304, receives a feedback voltage 314a and the pulse signal with the first frequency or the second frequency and then operates the feedback voltage 314a and the pulse signal to output the first control signal 308a and the second control signal 308b.

In an embodiment of the invention, the first control signal 308a and the second control signal 308b have 180° phase shift.

The power switch circuit 310 comprises a first power switch 310a and a second power switch 310b. The first power switch 310a is electrically to the pulse-width modulator 306 and receives the first control signal 308a. as well as determines whether to turn on the lamp in accordance with the received first control signal 308a. The second power switch 310b is electrically to the pulse-width modulator 306 and receives the second control signal 308b, as well as determines whether to turn on the lamp in accordance with the received second control signal 308b.

In an embodiment of the present invention, the first power switch 310a and the second power switch 310b may be, for example, a metal-oxide-semiconductor field effect transistor or a bipolar junction transistor, but not limited to.

Two power switches 310a, 310b have at least one grounded terminal and do not turn on at the same time, in addition, their turn-on working cycle is less than 50%.

The transformer unit 318 comprises a transformer 320 and a storage device 322. The transformer 320 is electrically coupled to the DC voltage source 312, the first power switch 310 and the second power switch 310b. The transformer 320 receives a DC voltage supplied from the DC voltage source 312 and converts the DC current to an alternating current and then outputs it as if the first power switch 310a and the second power switch 310b are turned on alternatively. The ballast device 322 is electrically coupled to the transformer 320 and the fluorescent tube 324 to ballast the alternating current and output the alternating current to the fluorescent tube 324.

In the embodiment of the invention, the storage device 322 may be, for example, a capacitor, but not limited to.

The turn-on detecting signal 316a indicating the turn-on state of the fluorescent tube of the present invention is further used to control an initiating timing for dimming the fluorescent tube. In the present embodiment, in the case where the turn-on detecting signal 316a indicates the fluorescent tube is turned on, a dimming control switch 330 is turned on and a dimming signal 328 is inputted to the pulse-width modulator 306 to change its outputs, the first control signal 308a and the second control signal 308b. The advantage of the initiating dimming function of the turn-on detecting signal 316a is to ensure that the fluorescent tube has a sufficient initiating power and time.

In practical applications, the dimming signal 328 may be a stable DC voltage input, or a low frequency pulse signal, for example, between 100 Hz˜1.5 KHz.

In practical applications, the turn-on detecting signal 316a indicating the turn-on state of the fluorescent of the invention is further used to indicate the abnormality of the system and protect the system. A protection circuit 332 outputs a protection signal 334 to change the first control signal 310a and the second control signal 310b of the pulse-width modulator 306 for preventing the power switch circuit 310 from turning on the fluorescent tube when the turn-on detecting signal 316a indicates the fluorescent tube 324 is turned off for a period exceeding a predetermined time, for example, a duration of one second.

Furthermore, in the protection circuit 332, a detecting signal 336 (shown by the dashed line) is added to indicate the output voltage of the transformer 320 to determine whether the fluorescent tube is turned on. The protection circuit 33 outputs an abnormality-indicating signal 316a for indicating the fluorescent tube is tuned off when the output of the transformer exceeds a predetermined value.

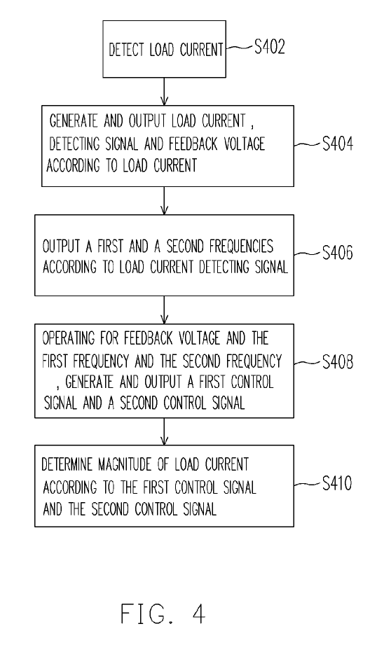

Referring to FIG. 3 and FIG. 4, wherein FIG. 4 shows a flow chart of an operating method for a fluorescent tube control system of the preferred embodiment of the invention.

In the operating method according to the preferred embodiment, the detecting circuit 326 is initiated for detecting an operating status (s402), and outputs the feedback voltage 314a (s404) for indicating the current passing through the fluorescent tube in accordance with the turn-on detecting signal 316a for indicating the fluorescent tube is turned on.

Then, the fixed frequency generator 304 outputs the pulse signal with the first and the second frequencies to the pulse-width modulator 306 (s406) in accordance with the turn-on detecting signal. Next, the pulse-width modulator 306 operates the feedback voltage 314a and the pulse signal with the first frequency or the second frequency and then outputs the first and the second control signals (s408).

Thereafter, the transformer 320 determines the magnitude of power supplied to the fluorescent lamp 324 (s410) in accordance with the turn-on cycle of the first power switch 310a and the second power switch 310b activated by the first control signal 308a and the second control signal 308b.

In an embodiment of the invention, the fluorescent tube needs a driving voltage 2˜3 times higher than that used in a normal operating state when initiated so that the fixed frequency generator 304 outputs a higher frequency for raising the coupling efficiency of the transformer and thus raising an output voltage. When the fluorescent tube 324 operates in a normal state, the fixed frequency generator 304 outputs a lower frequency, which prevents dissipation caused by a high frequency signal passing through a parasitic capacitor.

In conclusion, the invention employs two set fixed frequencies to drive the fluorescent tube in accordance with the requirements of the features of the fluorescent tube so that the invention can ignite and drive the fluorescent tube with a transformer having a low coil number ratio, thereby reducing difficulties in designing the transformer and thus increase the efficiency of the system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A fluorescent tube driver system, receiving a feedback signal for indicating an operating status of a fluorescent tube and driving the fluorescent tube in accordance with the received feedback signals, the fluorescent tube driver system comprising:
a frequency generator, receiving the feedback signal for determining and outputting a pulse signal with one of a first frequency and a second frequency;
a power control signal generating device, receiving the pulse signal and outputting a first control signal and a second control signal in accordance with the pulse signal and the feedback signal;
a protection circuit, receiving the feedback signal for determining whether or not to change the first control signal and the second control signal;
a power switch circuit, for receiving the first control signal and the said second control signal, comprising:
a first power switch controlled by the first control signal; and
a second power switch controlled by the second control signal;
wherein both duty cycles of the first power switch and the second power switch are less than 50%.

2. The fluorescent tube driver system according to claim 1, wherein the first control signal and the second control signal have different phases.

3. The fluorescent tube driver system according to claim 1, wherein the feedback signal is a detecting signal of a current passing through the fluorescent tube.

4. The fluorescent tube driver system according to claim 1, wherein the feedback signal is a detecting signal of a voltage of the fluorescent tube.

5. A dimmable fluorescent tube driver system, receiving a feedback signal for indicating an operating status of a fluorescent tube and driving the fluorescent tube in accordance with the feedback signal, the dimmable fluorescent tube driver system comprising:
a frequency generator, receiving the feedback signal for determining and outputting a pulse signal with one of a first frequency and a second frequency;
a power control signal generating device, receiving the pulse signal and outputting a first control signal and a second control signal in accordance with the pulse signal and the feedback signal;
a protection circuit, receiving the feedback signal for determining whether or not to change the said first control signal and the said second control signal;
a power switch circuit, receiving the first control signal and the second control signal, comprising:
a first power switch controlled by the first control signal;
a second power switch controlled by the second control signal; and
a light-dimming device, receiving the feedback signal for determining whether or not to output a light-dimming signal.
wherein both duty cycles of the first power switch and the second power switch are less than 50%.

6. The dimmable fluorescent tube driver system according to claim 5, wherein the first control signal and the second control signal have different phases.

7. The dimmable fluorescent tube driver system according to claim 6, wherein a frequency of the light-dimming signal is determined based on a clock signal of a liquid crystal display.

8. A fluorescent tube driver circuit, comprising:
a frequency generator, receiving a feedback signal which indicating an operating status of the fluorescent tube, and outputting a pulse signal with one of a first frequency and a second frequency;
a power control signal generating device, receiving the pulse signal and outputting a set of control signals in accordance with the pulse signal and the feedback signal; and
a power switch circuit comprising at least one switch, coupled to a power source and outputting an electric power of the power source in accordance with the set of control signals.

9. The fluorescent tube driver circuit according to claim 8, further comprises a protection circuit receiving the feedback signal for determining whether or not to disable the power control signal generating device in accordance with the feedback signal.

10. The fluorescent tube driver circuit according to claim 8, wherein the power switch circuit is a half-bridge power switch circuit.

11. The fluorescent tube driver circuit according to claim 8, wherein the feedback signal is a detecting signal of a current passing through the fluorescent tube.

12. The fluorescent tube driver circuit according to claim 8, wherein the feedback signal is a detecting signal of a voltage of the fluorescent tube.

13. The fluorescent tube driver circuit according to claim 8, further comprises a light-dimming device, receiving the feedback signal for determining whether or not to output a light-dimming signal.

14. The fluorescent tube driver circuit according to claim 13, wherein a frequency of the light-dimming signal is determined based on a clock signal of a liquid crystal display.
